(19) United States
(12) Patent Application Publication
(10) Pub. No.: US 2003/0097593 A1
(43) Pub. Date: May 22, 2003

(54) User terminal authentication program

(75) Inventors: Kazuhiro Sawa, Shizuoka (JP); Ken Okuyama, Shizuoka (JP); Satoshi Itaya, Shizuoka (JP); Tatsuhiro Sato, Kawasaki (JP); Fusako Takahashi, Kawasaki (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 10/108,396

(22) Filed: Mar. 29, 2002

(30) Foreign Application Priority Data
Nov. 19, 2001 (JP) 2001-353710

(51) Int. Cl. H04L 9/32

(52) U.S. Cl. 713/201

(57) ABSTRACT

A user terminal authentication program of the present invention is configured by a first step of displaying data of the authentication process of a user terminal, and dynamically preparing a terminal information object in a unification form that does not depend on a terminal type, using data of the request from a user terminal; a second step of selecting an authentication method suitable for a user terminal from among a plurality of authentication methods, such as a basic authentication method, a form authentication method, a terminal specific ID authentication method, in correspondence with contents of the prepared terminal information object; and a third step of executing an authentication procedure of the user terminal using the selected authentication method.

### BACKGROUND OF THE INVENTION

1. Field of the Invention

The present invention relates to an authentication method of a user terminal in a network system. More particularly, it relates to a user terminal authentication technology that dynamically determines the ability of a terminal using the data of the requests for services transmitted from various user terminals that are used in the Internet system, and that can select the respective authentication methods suitable for the user terminals that issue the requests.

2. Description of the Related Art

With the development of the Internet technology in recent years, various types of terminals that are provided with the Internet browsers have appeared. The number of the types have been increasing year by year.

Conventionally, a preparer of Web contents prepares the contents only for the terminal of a personal computer. At present, however, various types of terminals that differ in ability appeared and a preparer has to give careful consideration for the programming in accordance with the ability of a terminal, for example, a description language (mark-up language), an authentication method, etc.

In other words, only a personal computer is conventionally used as an application terminal of the Internet, and accordingly, a plurality of types of terminals need not be supported. In recent year, however, a plurality of terminals should be supported due to the appearance of various types of mobile terminals such as a Web phone, a car navigator, a Personal Digital Assistance (PDA), etc.

As a method of supporting a terminal on a server side, two methods are fundamentally available. The first method is a single terminal support server method. Since the function and ability differ in accordance with the type of a terminal, the first method is to provide a Web system (Web server) for each terminal type. Only one server supports one terminal type.

The second method is a plurality-terminal support server method. In this method, the difference in functions or ability of terminals is taken into consideration by the program (Servlet, CGI, etc.) of a Web system, and a plurality of types of terminals are supported by one server.

Meanwhile, an authentication method of a terminal is primarily influenced by the ability of a terminal. At present, various types of authentication methods, such as a basic authentication method, a form authentication method, a terminal specific ID authentication method, a fingerprint authentication method, a voiceprint authentication method, a retina authentication method, etc., are installed or are being developed, and the prompt supports to those methods are requested. Also, in recent years, a terminal type which can support a plurality of authentication methods has been generally used.

Here, a basic authentication method is an authentication method of using the basic authentication function of a terminal. In this method, an authentication process is executed by returning the cord of a certain specific HTTP (Hyper Text Transfer Protocol) to a terminal side from a Web server, by displaying a user name and the input field of a password on a terminal side (browser), and by user-inputting these items.

Meanwhile, this basic authentication method is regulated by an RFC (Request for Contents) prepared by the IETF (Internet Engineering Task Force) which standardizes the Internet related technology, so that this method is used worldwide. In this method, however, a defect of the security is a problem. Next, according to the form authentication method, a form (screen) that has the input fields for a user name and a password is prepared on the side of Web application, and this form is transmitted to the terminal side, and the user name and the password is inputted at the terminal side, thereby executing an authentication process. The difference from the basic authentication method is that the preparation of a form is not executed by the function of a terminal (browser) side.

And, the terminal specific ID authentication method is an authentication method of using a specific identifier (ID) that is assigned to a terminal. For example, a terminal specific ID, in other words, a subscriber ID is extracted from an HTTP header etc., inside a service request from a user terminal, thereby executing an authentication process using a value of the ID.

As mentioned above, a method of supporting a single terminal and a method of supporting a plurality of terminals are available, when each type of terminal is supported. In the former method, a Web system should be configured for each terminal type, which is a big burden to the preparer of a system. As the types of new terminals increase, the same operation should be repeatedly executed. Therefore, the following problems arise: the method is not effective concerning resources; in the case that many terminal types should be supported, the practicality of this method is not good, making this method useless.

In the second method, there is a problem such that individual terminal ability cannot be sufficiently utilized since it is influenced by a terminal type with low-level function and performance, among a plurality of terminal types.

In a conventional authentication method, one authentication method is selected in accordance with a terminal type with the lowest function level, using a support server method for a plurality of terminals. For example, a form authentication method which can be used by most terminal types is selected. However, there is a problem that an optimum authentication method for each terminal type cannot be selected, so that the authentication method of utilizing the performance of a terminal to the full extent cannot be selected for each terminal type.

### SUMMARY OF THE INVENTION

The subject of the present invention is to offer a user terminal authentication program for easily and dynamically selecting the authentication method that can utilize the performance of a terminal to the full extent from among a plurality of candidates of an authentication method, considering the above-mentioned problem.

A user terminal authentication program of the present invention is configured by the first step (1) of displaying data of the authentication process of a user terminal and dynamically preparing a terminal information object in a unified form that does not depend on a terminal type, using data of a request from the user terminal; a second step (2) of selecting an authentication method suitable for a user terminal from among a plurality of authentication methods such as a basic authentication method, a form authentication method, a terminal specific ID authentication method, etc., in correspondence with the contents of the prepared terminal information object; and a third step (3) of executing an authentication procedure for the user terminal using the selected authentication method.

### BRIEF DESCRIPTION OF THE DRAWINGS

FIG. 1 is a block diagram showing a basic function of the present invention;

FIG. 2 is a block diagram showing the configuration of an authentication system including a Mobile Agent;

FIG. 3 is a block diagram explaining a basic process using the mobile agent;

FIG. 4 illustrates an example of the contents of a setting file;

FIG. 5 illustrates the fundamental sequence of an authentication process;

FIG. 6 is a table explaining a matrix used for determining an authentication method;

FIG. 7 illustrates an authentication process phase;

FIG. 8 is a block diagram explaining a basic authentication method;

FIG. 9 is a block diagram explaining a terminal specific ID authentication method;

FIG. 10 is a block diagram explaining a form authentication method;

FIG. 11 is a block diagram explaining a form and terminal specific ID authentication method;

FIG. 12 is a block diagram explaining a no-authentication method;

FIG. 13 illustrates one example of an HTTP header;

FIG. 14 illustrates the data form of an HTTP header analysis table;

FIG. 15 illustrates one example of an HTTP parameter;

FIG. 16 is a table showing the data form of an HTTP parameter analysis table;

FIG. 17 is a table showing the data form of a terminal information object;

FIG. 18 is a flowchart of processes of HTTP header parameter analysis and preparation of a terminal information object;

FIG. 19 is a detailed flowchart of a terminal information object preparation process;

FIG. 20 is a detailed flowchart of an authentication process; and

FIG. 21 is a block diagram explaining a loading process of a program into a computer, in the present invention.

### DESCRIPTION OF THE PREFERRED EMBODIMENTS

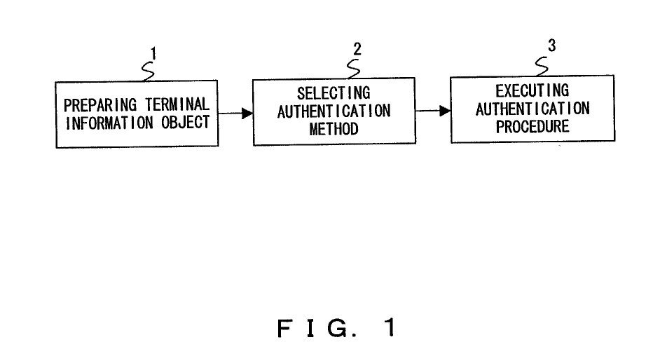

FIG. 1 is a block diagram showing a basic function of a user terminal authentication program of the present invention. This is a block diagram showing the basic function of a user terminal authentication program that is used by a computer for executing the authentication process of a user terminal, corresponding to the request for service from the user terminal.

In FIG. 1, the user terminal authentication program is composed of the following three processes. The first step is to display data about the authentication process of a user terminal and dynamically prepare a terminal information object in a unified form that does not depend on a terminal type, using the date of a request from a user terminal. The second step is to select an authentication method suitable for a user terminal from among a plurality of authentication methods such as a basic authentication method, a form authentication method, a terminal specific ID authentication method, etc., in correspondence with the contents of the prepared terminal information object.

The third step is to execute authentication procedures of a user terminal using the selected authentication method. These steps are executed in order from the first step.

According to an embodiment of the present invention, a computer for executing the authentication process of a user terminal is provided with a storage unit of a terminal information repository indicating the data of the authentication process of a terminal. In the first step of preparing a terminal information object, the computer can supplement data of the request that is insufficient from a user terminal, using the contents of the terminal information repository, and it can prepare a terminal information object.

Further, a computer for executing the authentication process of a user terminal is provided with a storage unit of a default terminal information repository indicating the data of the authentication process of a default terminal. When the type of a user terminal is not specified, the computer can supplement data of the request that is insufficient from a user terminal, using the contents of a default terminal information repository, and it can prepare a terminal information repository, in the first step of preparing a terminal information object.

In an embodiment, a computer for executing the authentication process of a user terminal can be provided with a storage unit for storing the order of priority among a plurality of authentication methods. Further, in the second step of selecting an authentication method, an authentication method with high priority can be selected corresponding to the contents of a terminal information object, among authentication methods applicable to a user terminal.

In an embodiment, a computer for executing the authentication process of a user terminal is provided with a storage unit for storing the terminal information object prepared in the first step of preparing the terminal information object, in preparation for a request for the next service in a series of communications from the user terminal. Further, the above-mentioned computer can use the storage contents of the storage unit of the terminal information object, in the first step of preparing the terminal information object in correspondence with a request for the next service from a user terminal.

In an embodiment, a device for executing the authentication process of a user terminal in correspondence with a request for service from a user terminal, is provided with a unit (1) of displaying data of the authentication process of a user terminal and dynamically preparing a terminal information object in a unified form that does not depend on a terminal type, using the data of a request from a user terminal, a unit (2) of selecting an authentication method suitable for a user terminal from among a plurality of authentication methods in correspondence with the contents of the prepared terminal information object, and a unit (3) executing authentication procedures for a user terminal using the selected authentication method.

In an embodiment, as a method of executing an authentication process of a user terminal in correspondence with a request for service from a user terminal, a method of (1) displaying data of the authentication process of a user terminal, and dynamically preparing a terminal information object in a unified form that does not depend on a terminal type, using the data of a request from a user terminal, (2) selecting an authentication method suitable for a user terminal from among a plurality of authentication methods, in correspondence with the prepared terminal information object, and (3) executing authentication procedures for a user terminal, using the selected authentication method, is used.

In an embodiment, as a storage medium to be used by a computer for executing an authentication process of a user terminal in correspondence with a request for service from a user terminal, a computer-readable portable-type storage medium storing a program causing a computer to execute the steps of (1) displaying data of the authentication process of a user terminal and dynamically preparing a terminal information object in a unified form that does not depend on a terminal model, using the data of a request from a user terminal, (2) selecting an authentication method suitable for a user terminal from among a plurality of authentication methods in correspondence with the prepared terminal information object, and (3) executing authentication procedures for a user terminal, using the selected authentication method, is used.

According to the present invention, the terminal information object in the unification form that indicates data suitable for the ability of the terminal and the authentication process of a terminal is prepared, and an authentication method suitable for the user terminal is selected, by using the data of a request for service from a user terminal. Thus various types of authentication methods are supported, and accordingly various types of terminals can be supported.

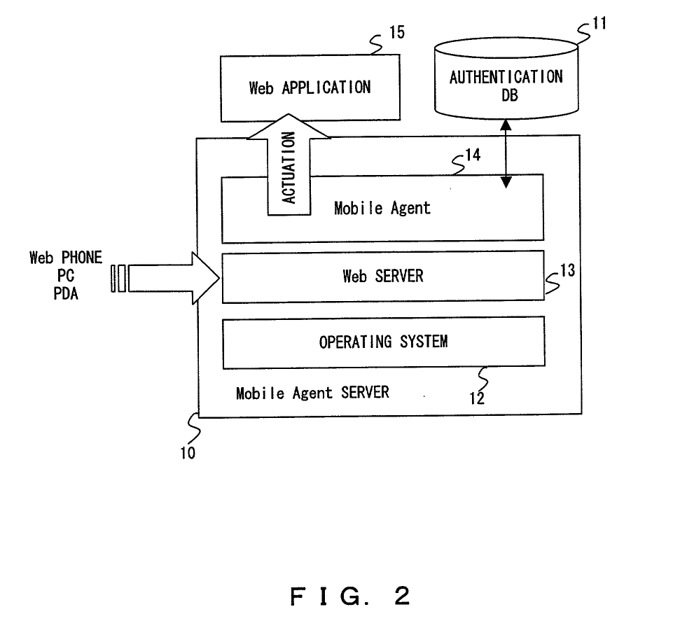

FIG. 2 is a block diagram showing an authentication system including a Mobile Agent that dynamically executes the authentication process of a user terminal. In this drawing, the system is basically configured by a Mobile Agent server 10 and an authentication database (DB) 11.

The mobile agent server 10 is configured by an operating system 12, a Web server 13, and a Mobile Agent 14. Fundamentally, the Mobile Agent 14 is a program for dynamically executing the authentication process of a user terminal, and for activating a Web application 15 when the validity of the user terminal is acknowledged as a result of the authentication process.

In other words, the Web application 15 in many cases restricts a user who can use the application. When a request is issued from a terminal, it is authenticated whether the user can use the application, and this process is executed by the Mobile Agent 14.

In FIG. 2, a request for the Web application from a Web phone, a PC (Personal Computer), or a PDA is received by the Web server 13. Then, the mobile agent 14 selects an authentication method suitable for a user terminal from among a plurality of authentication methods, using the contents of the authentication database 11. When the validity of the user terminal is acknowledged as a result of the authentication process, the Web application 15 is actuated.

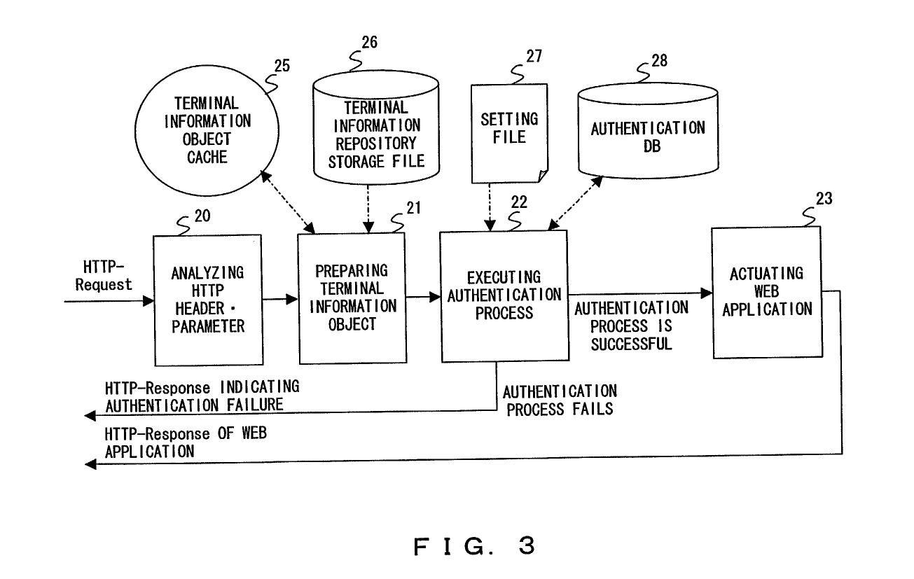

FIG. 3 illustrates the basic process executed by the Mobile Agent. In this drawing, processes are executed in order of an HTTP header•parameter analysis process 20, a terminal information object preparation process 21, an authentication process 22, and a Web application actuation process 23, in correspondence with a request for an HTTP (Hyper Text Transferal Protocol) from a user terminal, in other words, a request for the usage of a Web application.

In the HTTP header•parameter analysis process 20, the HTTP header and HTTP parameter that are included in the HTTP request from a user terminal are analyzed, and an HTTP analysis object is prepared. The contents of the HTTP analysis object include the contents of an HTTP header analysis table, an HTTP parameter analysis table, and a cookie analysis table which are described later, in addition to the URL (Uniform Resource Locater) of an application, the length of the contents, and HTTP basis information such as the HTTP version.

In the terminal information object preparation process 21, the carrier (communication employer) and type of user terminal that issues an HTTP request are specified on the basis of the data of an HTTP analysis object. In the case that this request is the first request issued in a session as a series of communications in which requests/answers are repeated between a user terminal and the Web server 13, a terminal information repository storage file 26 corresponding to the carrier and the model, is loaded. This terminal information repository indicates the ability and the authentication relation data of a terminal, etc., which are described in detail later. Using the information of the loaded terminal information repository and the HTTP analysis object, a terminal information object is prepared. Meanwhile, this terminal information repository is loaded to obtain the information that is not obtained by the contents of the HTTP analysis object. In the case that sufficient information can be obtained, such a loading process is not required.

In the case that the HTTP request from a user terminal is issued within the already-started session, for example, the next request, a terminal information object corresponding to this session is cached by a terminal information object cache 25. In the terminal information preparation process 21, a terminal information object is loaded from this cache 25, and the required information in the HTTP analysis object is written over the terminal information object, thereby preparing a terminal information object. The prepared terminal information object is registered in the terminal information object cache 25, while setting the ID of the session as a key, in preparation for the input of the next HTTP request.

In the authentication process 22, any one of a plurality of authentication methods is selected in accordance with the contents of a terminal information object, and the authentication process for a user terminal is executed. At this time, an order of priority of authentication methods is established in a setting file 27. The authentication methods are evaluated from a method with high priority, and the authentication method is determined. This order of priority is determined by the controller of a Web system including the mobile agent server 10 of, for example, FIG. 2. For example, the controller sets the authentication method with a high security level as the authentication method with high priority.

Using the determined authentication method, various types of data, for example, a user's name, passwords, etc., required for the authentication process are obtained, and an authentication database 28 is accessed, thereby checking the validity of a user terminal. Furthermore, the authentication DB11 can be a database connected to another server that can be accessed through, for example, a network.

In the case that the authentication process fails, an error message to inform a user of this failure, that is, an HTTP response indicating authentication failure is transmitted, and the error message is displayed on the side of a user terminal. As occasion demands, the re-input of various types of authentication data is required for a user.

In the case that the authentication process is successful, the Web application actuation process 23 is executed, and then the HTTP response of the Web application is returned to a user side.

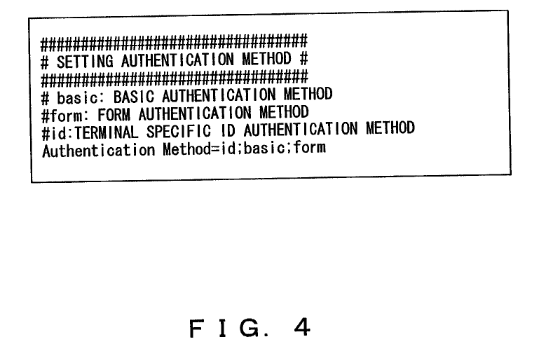

FIG. 4 illustrates an explanation of a setting file 27 of FIG. 3. In this drawing, a basic authentication method, a form authentication method, and a terminal specific (subscriber) ID authentication method are designated as three authentication methods. Meanwhile, a line having “#” at the top is a comment, and this line has nothing to do with a process. The last line defines the order of priority. Here, it is designated that the first priority is a terminal specific ID authentication method, the second priority is a basic authentication method, and the third priority is a form authentication method.

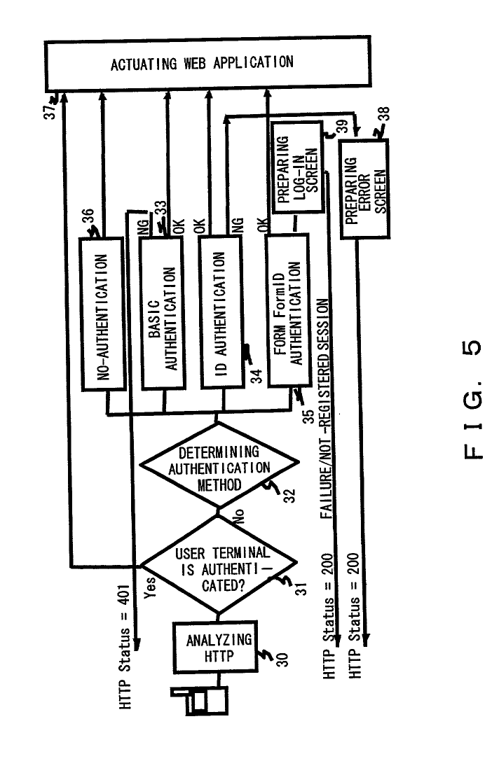

FIG. 5 illustrates the fundamental sequence of authentication processes. In this drawing, an HTTP analysis process 30 is firstly executed for the request from a user terminal. This analysis process corresponds to the HTTP header•parameter analysis process 20 and the terminal information object preparation process 21 of FIG. 3.

Next, a determination process 31 of determining whether an authentication process terminates is executed. In the case that an authentication process terminates due to the previous access, an application actuation process 37 is immediately executed. In the case that an authentication process does not terminate, a process advances to an authentication method decision process 32.

In the authentication method decision process 32, any one of a plurality of authentication methods (here, four authentication methods) such as a basic authentication method 33, a terminal specific ID authentication method 34, a form ID authentication method 35 functioning as a form authentication method or functioning as a combination of a form authentication method and a terminal specific ID authentication method, and a no-authentication method 36 for bypassing authentication processes, is determined.

If the authentication result is successful in the phase of an authentication process, for example, the basic authentication method 33, an application actuation process 37 is executed. If the authentication process fails, in other words, is not successful, the error message of, for example, an HTTP status 401 is returned to a user terminal side.

In the case that an authentication process fails when a terminal specific ID authentication method 34 of an authentication processing phase is executed, an error screen preparation process 38 is executed. The error message of an HTTP status 200 is returned to a user terminal side.

Further, in the case that it is determined that registration fails due to a form authentication method or the form ID authentication method 35, or the session is unregistered, a log-in screen preparation process 39 is executed, and a screen that prompts for the input of the data needed for an authentication process is transmitted to a user terminal side as the HTTP status 200.

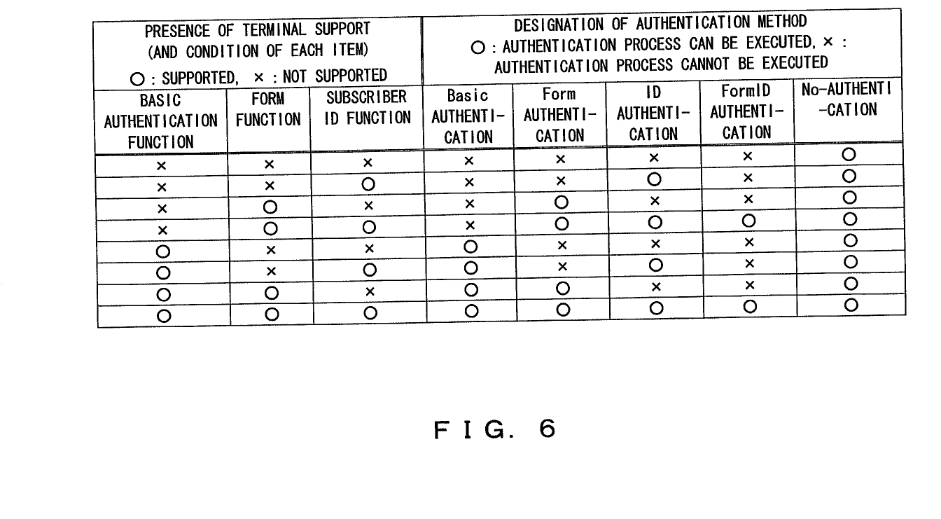

FIG. 6 shows a matrix for determining an authentication method in the authentication method decision process 32 of FIG. 5. At the left side of FIG. 6, a circle indicates that the respective basic authentication method, form authentication method, and subscriber ID authentication method are supported by a user terminal, while X indicates that these methods are not supported by a user terminal.

The right side of FIG. 6 illustrates whether an authentication process can be executed for the respective basic authentication method, form authentication method, terminal specific ID authentication method, form ID authentication method, and no-authentication method, in correspondence with the combination on the left side.

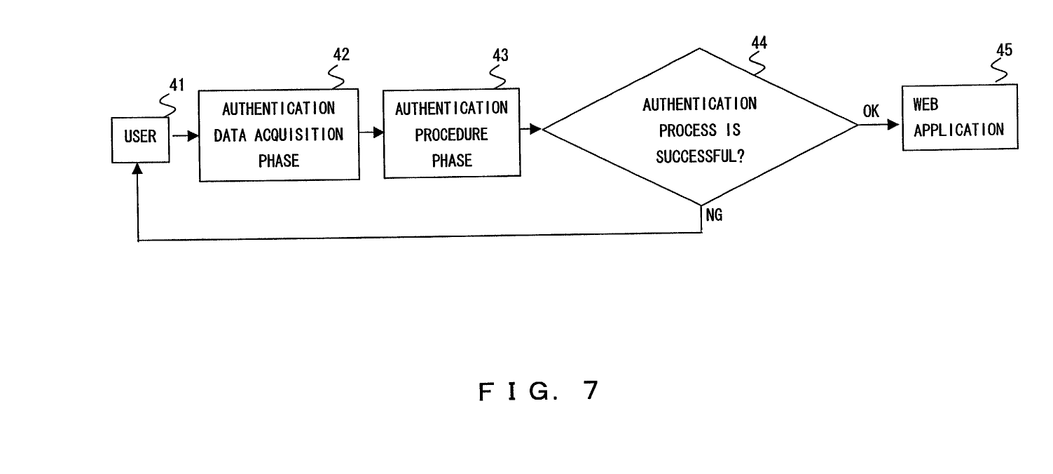

FIG. 7 illustrates an explanation of a process phase of the authentication process phase of FIG. 5, for example, a process phase of the basic authentication method 33. The authentication process phase is divided into an authentication data acquisition phase 42 and an authentication process phase 43. Here, the request from a user 41 is input to the authentication data acquisition phase 42. A determination process 44 determining whether the authentication process is successful, is executed corresponding to the result of the authentication process phase 43. If the authentication process is successful, the application 45 is actuated. In the case of authentication failure, an error message, etc., is returned to the user 41.

An authentication data acquisition phase 42 corresponds to a phase between the HTTP analysis process 30 and the authentication method decision process 32 of FIG. 5. Data needed for the authentication process is obtained by analyzing an HTTP header and an HTTP parameter of a request to which a user name, a password, etc., are input from the user 41.

The validity of a user terminal is checked by using the obtained data, in the authentication process phase 43. In this check, an authentication mechanism with a cassette configuration such as an LDAP (Light Weight Directory Access Protocol) authentication service, etc., is read out, and an authentication process is executed. If the authentication process is successful, the screen of the application that is designated by a URL is displayed on a terminal side.

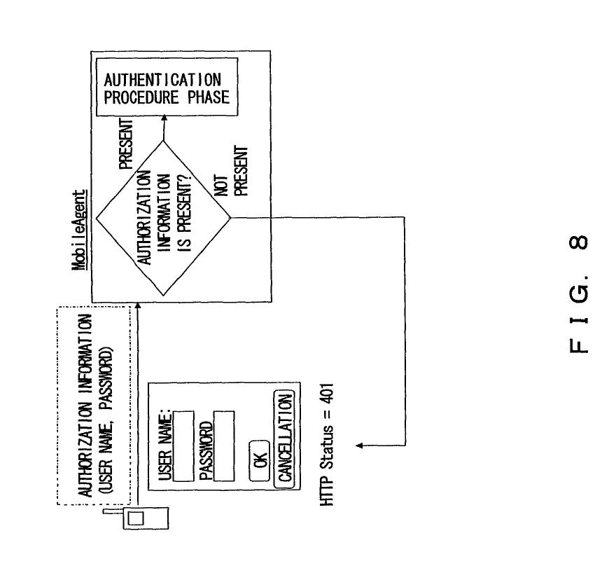

FIGS. 8 to 12 are detailed diagrams of the authentication process phases corresponding to the respective authentication methods. FIG. 8 is a block diagram showing the basic authentication method 33, and an authentication process is executed using the authentication function (screen) of a terminal.

In FIG. 8, the authorization information in the HTTP header that is transmitted from a user terminal, is extracted, and the user name and password are obtained. In the case that the authorization information, in other words, the user name and password are not present, an HTTP status cord 401 is returned to a terminal side in order that an authentication input screen is displayed on a terminal side. In the case that a user name, passwords, etc., can be obtained, an authentication process phase is executed. In the case that a user name and a password do not agree in the authentication process phase, and an authentication process fails, the HTTP status 401 may be returned to a terminal, so that it is possible that a user name and a password should be re-input as in the case that no authorization information is present.

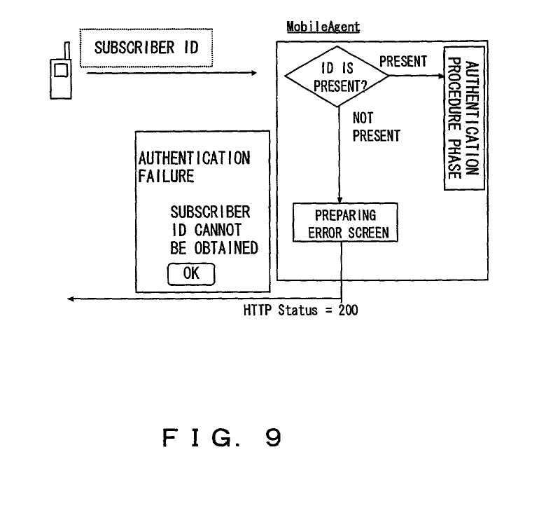

FIG. 9 is a block diagram explaining the terminal specific ID authentication method 34. Since an authentication process is executed by utilizing the terminal specific ID method that is allocated to a terminal, an authentication input screen is not required on a terminal side.

In FIG. 9, a terminal specific ID is extracted from an HTTP header analysis table (which is described later) for storing the analysis result of an HTTP header. In the case that there is no such ID, an error screen is prepared to be returned to a user terminal side as an the HTTP status 200. In the case that the terminal specific ID is extracted, an authentication process phase is extracted, and an authentication process is executed using the terminal specific ID. In the case that this authentication process fails, an error screen indicating that for example, terminal specific ID is not effective, is displayed on a terminal side, as in a case that there is no ID.

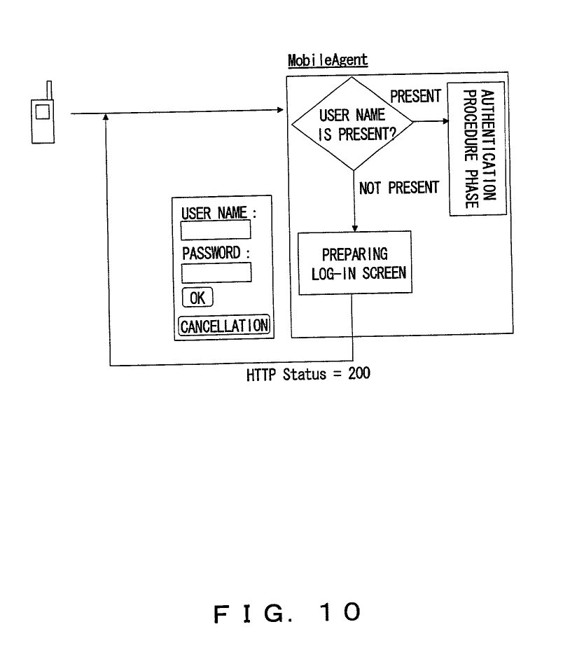

FIG. 10 is a block diagram explaining a form authentication method. In a form authentication method, a log-in screen held by a Mobile Agent is displayed on a user terminal side, and an authentication process is executed.

In FIG. 10, a user name, a password, and a URL of an application are extracted from an HTTP parameter analysis table that is described later. Then, it is determined whether the user name and the password are extracted. In the case that they are not extracted, a log-in screen is prepared to be displayed on a user terminal side as the HTTP status 200, and the input of the user name and password are required. In the case that the user name and password can be obtained, an authentication process phase is executed. In the case that the authentication process fails, an error screen is prepared to be transmitted to a user terminal side.

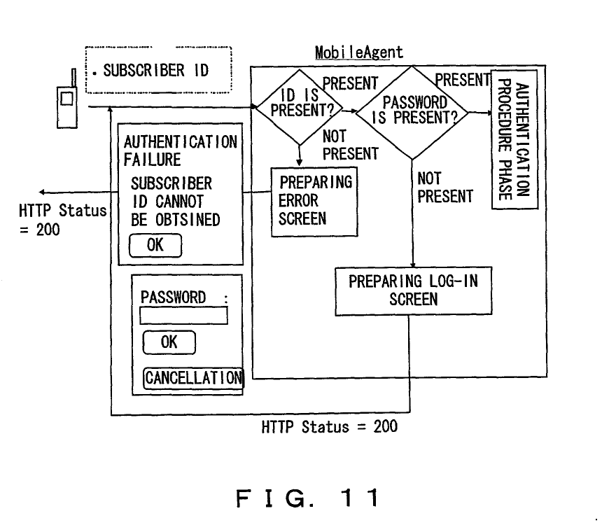

FIG. 11 is a block diagram explaining a form ID authentication method, in other words, a form and terminal specific ID authentication method. A terminal specific ID specific to a terminal is used instead of a user name, a log-in screen held by a Mobile Agent is used as occasion demands, and an authentication process is executed.

In FIG. 11, a terminal specific ID, a password, and a URL of an application are extracted from an HTTP header analysis table and an HTTP parameter analysis table. In the case that a terminal specific ID is not present, an error screen is prepared to be transmitted to a terminal as the HTTP status 200.

In the case that the terminal specific ID is extracted, it is determined whether a password is obtained. In the case that the password is not obtained, a log-in screen for requiring the input of the password is prepared. A user terminal side demands the input of a password as the HTTP status 200. In the case that a password is obtained, an authentication process phase is executed. In the case that, for example, the terminal specific ID and password are not effective, an error screen is prepared to be transmitted to a user terminal side.

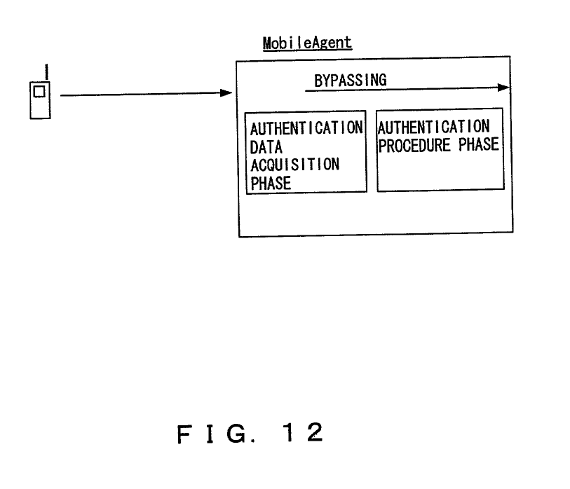

FIG. 12 is a block diagram explaining a no-authentication method. This authentication method is used as an authentication method for a guest user, and application can be substantially used without an authentication process. In other words, an authentication data acquisition phase and an authentication process phase are bypassed in this method. Then, an application is actuated, assuming that the authentication process is successful.

Next is an explanation of the data configuration of an HTTP analysis object and a terminal information object. The HTTP analysis object is data that is a combination of results obtained by analyzing the HTTP request information inputted from a user terminal. As mentioned above, this object is composed of the contents of HTTP basic information, an HTTP header analysis table, an HTTP parameter analysis table, and a cookie analysis table. The HTTP basic information is data such as the URL of an application, the length of contents, the version of an HTTP protocol, etc. The cookie analysis table has no direct relation with the present preferred embodiment, and accordingly, a detailed explanation is omitted.

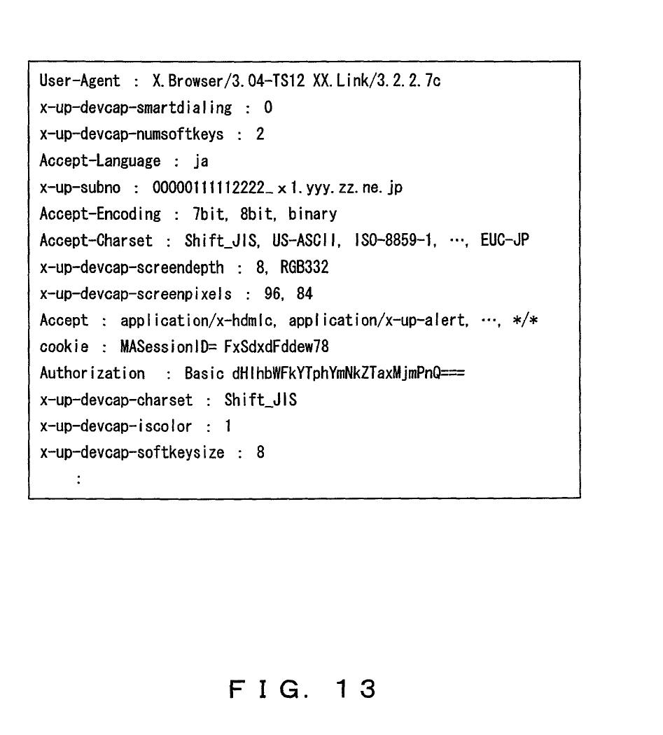

FIG. 13 illustrates an example of an HTTP header. This HTTP header is an example corresponding to a certain communication carrier. The data used in the present preferred embodiment are a user agent of the first line, x-up-subno (corresponding to a terminal specific ID) of the fifth line, and the above-mentioned authorization information of the twelfth line.

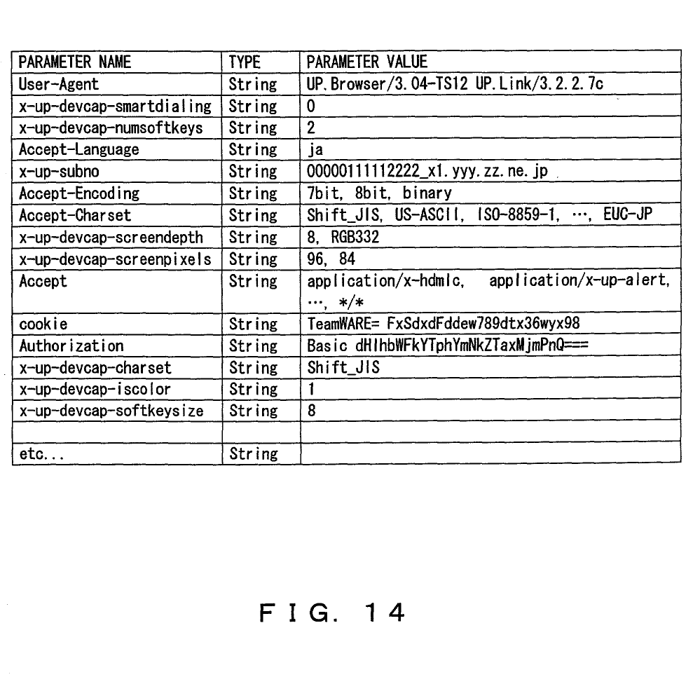

FIG. 14 shows an example of the data configuration of an HTTP header analysis table that is the result obtained by transforming the information of the HTTP header of FIG. 13. The data of this diagram is substantially identical to that of FIG. 13. The table of FIG. 13 is transformed to a table having columns of names of parameters, types of data, and values of parameters shown in FIG. 14.

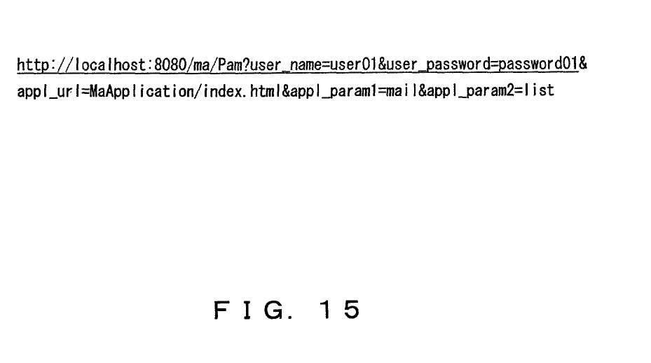

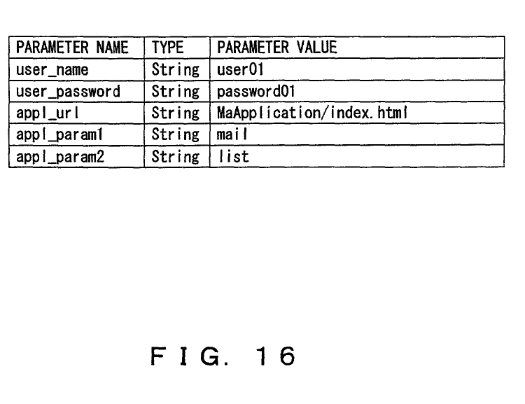

FIG. 15 is a table showing one example of an HTTP parameter. FIG. 16 shows data of an HTTP parameter analysis table obtained by transforming the HTTP parameter of FIG. 15. The data used by the present embodiment shown in FIG. 16 are a user name of the first line, a password of the second line and the URL of application of the third line.

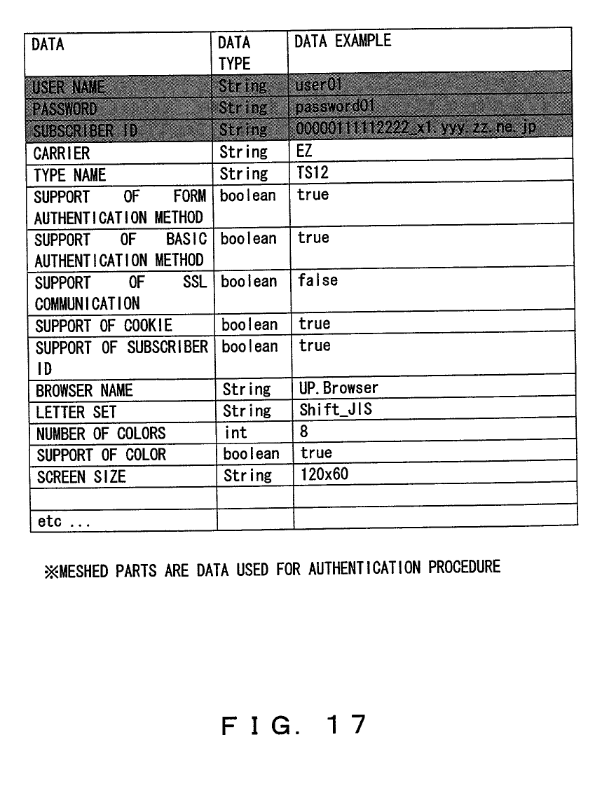

FIG. 17 is a table showing one example of the data of a terminal information object. The terminal information repository and terminal information object of FIG. 3 are substantially in the same form. The difference between them is that the terminal information repository is offered as the data inside a file. However, if the contents of the file are loaded to be expanded on a memory, the form of the expanded contents become the same as that of the terminal information object.

Accordingly, the terminal information object is a combination of data indicating the ability of a terminal. In the present embodiment, a user name, a password, and a subscriber ID between the first and the third lines from the top are used by an authentication process. In addition to these data, data about whether each authentication method is supported, the number of colors to be displayed indicating the specificatons of a terminal, a screen size, etc., is included.

The above-mentioned HTTP header analysis table, HTTP parameter analysis table, terminal information object, etc., are stored in a memory (not shown in the drawing) of the Mobile Agent server 10 of FIG. 2, thereby being used by the Mobile Agent 14.

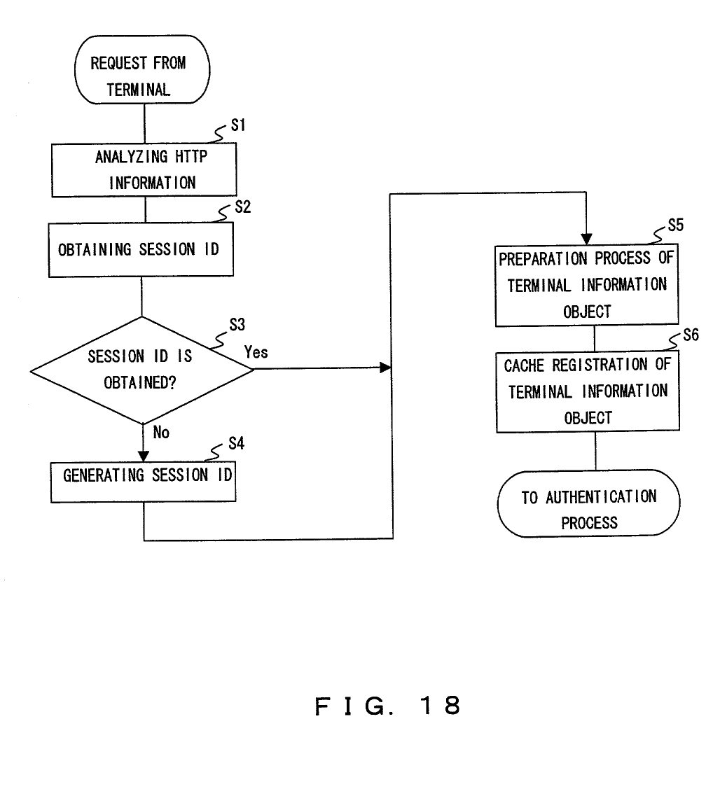

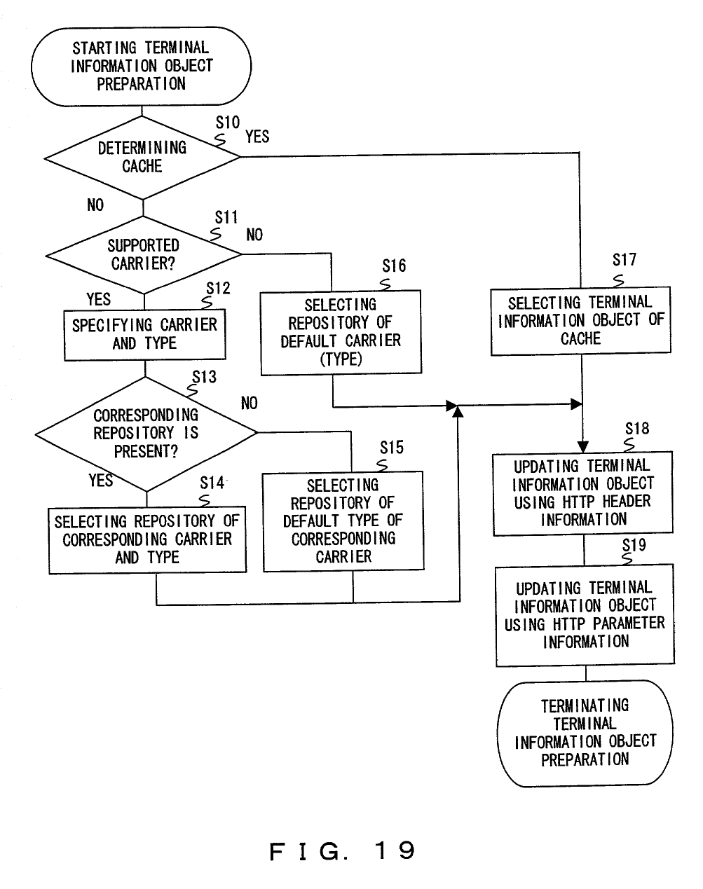

Next, the detailed process of the present embodiment is explained with reference to FIGS. 18 to 20. FIG. 18 is a processing flowchart of the HTTP header•parameter analysis process 20 of FIG. 3, and the terminal information object preparation process 21 of FIG. 3. FIG. 19 is a detailed flowchart of the terminal information object preparation process 21 of FIG. 3.

When a process starts corresponding to the request from a terminal in FIG. 18, the analysis of an HTTP header and an HTTP parameter included in the HTTP request transmitted from a terminal is executed as the analysis process of HTTP information at step S1, and the necessary information is stored as an HTTP analysis object.

At step S2, a session ID for specifying a session corresponding to a series of communications executed between a user terminal and, for example, the Web server 13 of FIG. 2, is obtained from the information of an HTTP analysis object. At step S3, it is determined whether the session ID is obtained. The session ID is stored in the cookie of the eleventh line of the table of FIG. 14.

In the case that the session ID cannot be obtained, the request is determined as a request issued when a series of communications starts. Then, a process immediately advances to the process of step S5 after a session ID corresponding to the series of communications is prepared at step S4 or in the case that the session ID is obtained.

At step S5, the preparation process of a terminal information object is executed by using the contents of an HTTP analysis object and a terminal information repository. The details of this process are shown in FIG. 19. At step S6, the terminal information object is cached in the terminal information object cache 25 of FIG. 3, in preparation for the next request issued from the user terminal in a series of communications. Then, a process advances to an authentication process. In this caching process, a session ID and a terminal information object are stored as a pair. This caching process eliminates a loading process of a terminal information repository, etc., at the time of the next request, thereby improving the performance and efficiency of the process executed by, for example the Mobile Agent shown in FIG. 3.

FIG. 19 is a detailed flowchart of a preparation process of the terminal information object at step S5 of FIG. 18. When the process starts in FIG. 19, a cache determination process is executed at step S10. In other words, it is determined whether the terminal information object is already cached in the terminal information object cache 25 of FIG. 3. As mentioned above, since a caching process of the terminal information object is executed while setting a session ID as a key, the terminal information object is not cached, and the processes at and after S11 are executed, when a session functioning as a series of communications starts.

At step S11, it is determined whether a carrier for a user terminal that issues a request is supported. In other words, it is determined whether the carrier is supported using the contents of an HTTP analysis object. This determination process is executed by the specific contents of a user agent for each carrier of the first line of the data stored inside the HTTP header analysis table explained in FIG. 14. In the case that the carrier is supported, a carrier and a terminal type are specified at step S12. Further, a terminal type is specified by analyzing the data of a user agent.

Subsequently at step S13, it is determined whether a terminal information repository corresponding to the specified carrier and terminal type is stored in the terminal information repository storage file 26 of FIG. 3. In the case that the repository is stored in the terminal information repository file, this repository is selected at step S14.

In the case that the repository is not stored, a terminal information repository corresponding to a default type of the carrier that is already specified at step S15, is selected. In the case that it is determined that the carrier is not supported at step S11, a terminal information repository corresponding to the Internet access program that is widely used by personal computers, is selected at step S16.

Then, at step S18, a terminal information repository, in other words, a terminal information object is updated using the information of an HTTP header analysis table, while setting the terminal information repository that is selected at steps S14, S15, and S16, as a model. At step S19, a terminal information repository, in other words, a terminal information object is updated using the information of an HTTP parameter analysis table, and then a terminal information object preparation process terminates.

If it is determined at step S10 based on a result of cache determination that the terminal information object used for the terminal that issues a request is cached, the terminal information object is selected at step S17, and processes at and after step S18 are executed. Furthermore, in the updating processes that are executed at steps S18 and S19, for example, a terminal information repository is used as a model. In these processes, a password and a user name that might be changed for each request, are updated.

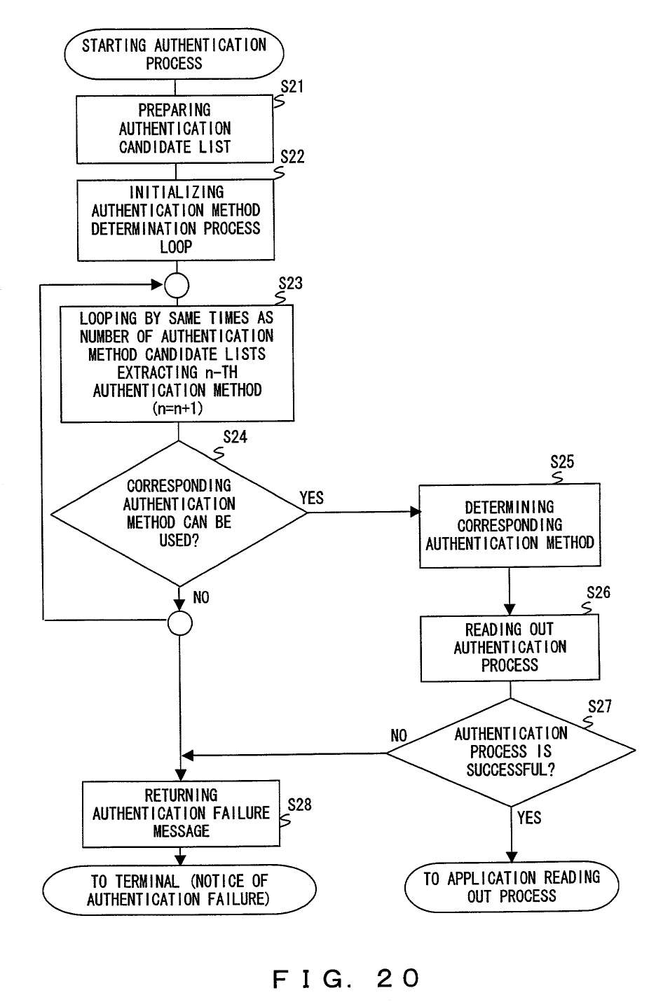

FIG. 20 is a detailed flowchart of the authentication process that follows the process of FIG. 18. When a process starts in this drawing, an authentication method candidate list is prepared at step S21. According to this process, a list is prepared in accordance with the contents of the setting file 27 of FIG. 3, in other words, the order of priority of the authentication method that is explained in FIG. 4. This process may be executed once at the time of the initialization of a Mobile Agent system. Otherwise, the order of priority of an authentication method of FIG. 4 may be loaded, instead of preparing an authentication method candidate list.

At step S22, a count value n of a counter for obtaining an authentication method is set 0 as an initialization process of an authentication method decision process loop. Then, the process of a loop that is configured at steps S23 and S24 is executed. In other words, the value of counter n is incremented at step S23. At first, the first item of the list, that is, an authentication method with the highest priority is extracted. At step S24, it is determined whether this authentication method can be used. In this determination, it is determined whether a user terminal that issues a request supports the authentication method, using the contents of a terminal information object. In the case that the method cannot be used, a process returns to step S23, the value n is incremented, and processes at steps S23 and S24 are repeated for the second and subsequent authentication methods.

In the case that it is determined that the n-th authentication method extracted at step S24 can be used, the n-th authentication method is determined to be selected at step 25. At step S26, an authentication process corresponding to the n-th authentication method is read out. At that time, a user name, passwords and other information needed for the n-th authentication process are obtained from an HTTP analysis object, and the n-th authentication process is executed.

At step S27, it is determined whether the n-th authentication process is successful. If the n-th authentication process is successful, the application is read out. The determination of the success of the n-th authentication is judged by referring to the returned information from the authentication procedure.

Processes at steps S23 and step S24 are repeated for all n authentication methods that are listed in an authentication method candidate list. If it is determined that there is no authentication method to be used, and if it is determined that the authentication process fails at step S27, a message of the authentication failure is sent to a terminal at step S28, thereby terminating processes.

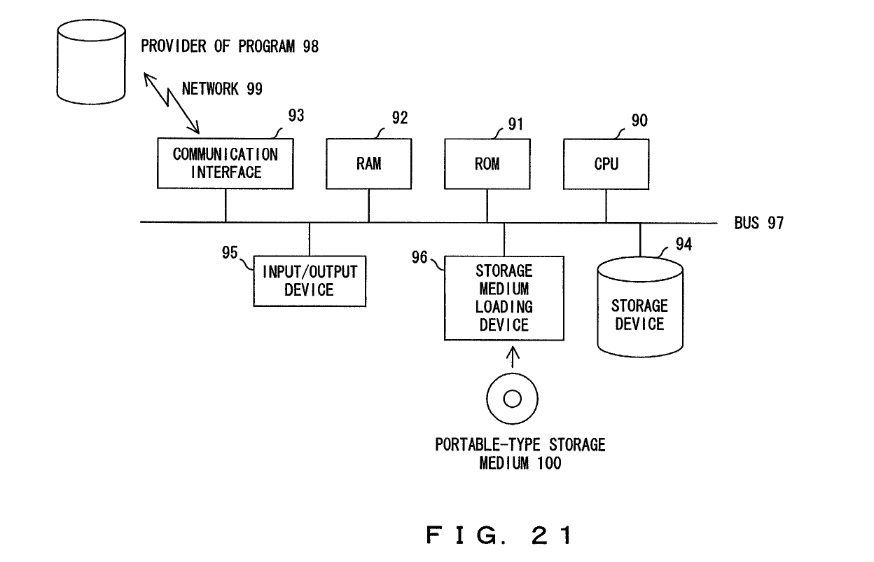

The above-mentioned explanations are details of a Mobile Agent functioning as a user terminal authentication program of the present invention. It is natural that a Mobile Agent can be realized by a general computer system. FIG. 21 is a block diagram showing the constitution of such a computer system, in other words, a hardware environment.

In FIG. 21, a computer system is configured by a Central Processing Unit (CPU) 90, a Read Only Memory (ROM) 91, a Random Access Memory (RAM) 92, a communication interface 93, a storage device 94, an input/output device 95, a portable-type storage medium loading device 96, and a bus 97 for connecting all the above-mentioned units.

As the storage device 94, various types of storage devices such as a hard disk, a magnetic disk, etc., can be used. In this storage device 94 or in the ROM 91, the programs shown in the sequence drawings and flowcharts of FIGS. 5, 7, and 18 to 20, and the programs of claims 1 to 5 are stored. By executing such a program by the CPU 90, the dynamic authentication process of a user terminal of the present embodiment becomes possible.

Such a program can be stored in, for example, the storage device 94 through a network 99 and the communication interface 93 from a program provider 98 side, and it can be executed by a CPU 90. Or it can enter the market, it can be stored in a commercially available portable-type storage medium 100, it can be installed in the loading device 96, and it can be executed by a CPU 90. As a portable-type storage medium 100, various types of storage media such as a CD-ROM, a flexible disk, an optical disk, and a magneto-optical disc can be used. By loading the programs that are stored in such storage media using the loading device 96, a terminal authentication process, etc., can be executed in correspondence with the order of priority of the predetermined authentication methods.

According to the present invention as mentioned above, a plurality of types of terminals and a plurality of authentication methods can be supported by only one Web system. Therefore, the problem with the preparation and maintenance of a Web system is decreased, and the usage of the resources becomes effective. Consequently, a content preparer can concentrate on the original content preparation work without being concerned with the ability such as specifications of a terminal.

Further, by preparing a terminal information object corresponding to the service request from a terminal, the optimal authentication method corresponding to the ability of a terminal can be dynamically selected. Still further, by changing the order of priority of an authentication method, an authentication method to be selected can be easily changed. Even in the case that the terminal type is not specified, a terminal information object can be prepared by using a default terminal information repository, so that the authentication process of an unknown terminal can be executed.

What is claimed is:

1. A user terminal authentication program used by a computer executing an authentication process of a user terminal in correspondence with a request of service from the user terminal, for causing the computer to perform:
displaying data of the authentication process of the user terminal, and dynamically preparing a terminal information object in a unification form that does not depend on a terminal type, using data of the request;
selecting an authentication method suitable for the user terminal from among a plurality of authentication methods in correspondence with the contents of the terminal information object; and
executing an authentication procedure for the user terminal, using the selected authentication method.

2. The user terminal authentication program according to claim 1, wherein
the computer is provided with a storage unit of a terminal information repository indicating data of the authentication process in accordance with a terminal type, and
the computer supplements data of the request that is insufficient from the user terminal using contents of the terminal information repository, and prepares the terminal information object, in a preparation step of the terminal information object.

3. The user terminal authentication program according to claim 1, wherein
the computer is provided with a storage unit of a default terminal information repository indicating data of an authentication process of a default terminal,
when a type of the user terminal is not specified, the computer supplements data of the request that is insufficient from the user terminal using contents of the default terminal information repository, and prepares the terminal information object, in a preparation process of the terminal information object.

4. The user terminal authentication program according to claim 1, wherein
the computer is provided with a storage unit storing an order of priority among a plurality of authentication methods, and
the computer selects a high-priority authentication method from among authentication methods that can be applied to the user terminal, in correspondence with contents of the terminal information object, in a selection process of the authentication method.

5. The user terminal authentication program according to claim 1, wherein
the computer is provided with a storage unit storing the terminal information object that is prepared in a preparation process of the terminal information object, in preparation for a request of next service in a series of communications from a same user terminal, and
the computer utilizes storage contents of a storage unit of the terminal information object in correspondence with a request of next service from the user terminal, in the preparation process of the terminal information object.

6. A user termination authentication device executing an authentication process of a user terminal in correspondence with a request of service from the user terminal, comprising:
a display-preparation unit displaying data of the authentication process of the user terminal, and dynamically preparing a terminal information object in a unification form that does not depend on a terminal type, using data of the request;
a selection unit selecting an authentication method suitable for the user terminal from a plurality of authentication methods in correspondence with the contents of the terminal information object; and
an execution unit executing an authentication procedure for the user terminal, using the selected authentication method.

7. A user terminal authentication method in correspondence with a request of service from a user terminal, comprising:
displaying data of an authentication process of the user terminal, and dynamically preparing a terminal information object in a unification form that does not depend on a terminal type, using data of the request;
selecting an authentication method suitable for the user terminal from a plurality of authentication methods in correspondence with the contents of the terminal information object; and
executing an authentication procedure of the user terminal, using the selected authentication method.

8. A computer-readable portable-type storage medium used by a computer executing an authentication process of a user terminal in correspondence with a request for service from a user terminal, and storing a program for causing the computer to execute:
displaying data of the authentication process of the user terminal, and dynamically preparing a terminal information object in a unification form that does not depend on a terminal type, using data of the request;
selecting an authentication method suitable for the user terminal from a plurality of authentication methods in correspondence with the contents of the terminal information object; and
executing an authentication procedure for the user terminal, using the selected authentication method.

9. A user terminal authentication device executing an authentication process of a user terminal in correspondence with a request for service from the user terminal, comprising:
display-preparation means for displaying data of an authentication process of the user terminal, and dynamically preparing a terminal information object in a unification form that does not depend on a terminal type, using data of the request;
selection means for selecting an authentication method suitable for the user terminal from among a plurality of authentication methods in correspondence with the contents of the terminal information object; and
execution means for executing the authentication procedure for the user terminal, using the selected authentication method.

10 A conveyance signal conveying a program used by a computer executing an authentication process of a user terminal in correspondence with a request of service from the user terminal, wherein
the program causes a computer to execute:
displaying data of the authentication process of a user terminal, and dynamically preparing a terminal information object in a unification form that does not depend on a terminal type, using data of the request;
selecting an authentication method suitable for the user terminal from among a plurality of authentication methods in correspondence with contents of the terminal information object; and
executing an authentication procedure of the user terminal using the selected authentication method.
